(19) United States
(12) Patent Application Publication
(10) Pub. No.: US 2016/0249132 A1
(43) Pub. Date: Aug. 25, 2016

(54) SOUND SOURCE LOCALIZATION USING SENSOR FUSION

(71) Applicant: INVENSENSE, INC., San Jose, CA (US)

(72) Inventor: Omid Oliaei, Sunnyvale, CA (US)

(21) Appl. No.: 14/628,806

(22) Filed: Feb. 23, 2015

(51) Int. Cl. H04R 1/40; H04R 3/00; H04R 19/04; H04R 1/32; H04R 19/00

(52) U.S. Cl. CPC H04R 1/406; H04R 1/326; H04R 19/005; H04R 19/04; H04R 3/005; H04R 2201/40

(57) ABSTRACT

Sound source localization using sensor fusion is presented herein. A device can include a sensor component that is configured to receive, from microphone(s), acoustic information corresponding to a sound source, and receive, from a set of sensors, motion information corresponding to the device. Further, the device can include a sensor fusion component that is configured to determine, based on the acoustic information and the motion information, coordinate information representing a location of the device with respect to the sound source, and send the coordinate information directed to a computing device. In an example, the sensor fusion component can determine an orientation of the device based on the motion information, and determine the coordinate information based on the orientation. In another example, the sensor fusion component can determine an angle of arrival of an acoustic wave from the sound source, and determine the coordinate information based on the angle of arrival.

### TECHNICAL FIELD

The subject disclosure generally relates to embodiments for sound source localization using sensor fusion.

### BACKGROUND

Conventional sound source localization technologies perform beamforming, speech enhancement, and noise cancelation utilizing software programs executed in a main processor. Although such technologies utilize microphones to localize a sound source and perform beamforming, sound source localization accuracy is limited due to use of a single type of sensor or microphone, and increased power consumption resulting from complex audio-based sound source localization algorithms being performed on the main processor. In this regard, conventional sound source localization technologies have had some drawbacks, some of which may be noted with reference to the various embodiments described herein below.

### BRIEF DESCRIPTION OF THE DRAWINGS

Non-limiting embodiments of the subject disclosure are described with reference to the following figures, wherein like reference numerals refer to like parts throughout the various views unless otherwise specified:

FIG. 1 illustrates a block diagram of a sensor fusion environment, in accordance with various embodiments;

FIG. 2 illustrates a block diagram of a sensor hub, in accordance with various embodiments;

FIG. 3 illustrates a block diagram of a sensor fusion environment including a coder-decoder (codec), in accordance with various embodiments;

FIG. 4 illustrates a block diagram of another sensor fusion environment including a codec, in accordance with various embodiments;

FIG. 5 illustrates a block diagram of yet another sensor fusion environment, in accordance with various embodiments;

FIG. 6 illustrates a block diagram of a sensor hub including an audio component, in accordance with various embodiments;

FIG. 7 illustrates a block diagram of a sensor hub within a reduced power environment, in accordance with various embodiments;

FIG. 8 illustrates a block diagram of a sensor fusion system, in accordance with various embodiments;

FIG. 9 illustrates a block diagram of a sensor fusion environment including a master microphone, in accordance with various embodiments; and

FIGS. 10-13 illustrate flowcharts of methods associated with a sensor hub, in accordance with various embodiments.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

Conventional audio technologies have had some drawbacks with respect to performing sound source localization. Various embodiments disclosed herein can improve sound source identification and system power consumption by utilizing a sensor hub coupled to motion sensor(s) to determine a location, coordinates, etc. of a sound source.

For example, a device, e.g., sensor hub, can comprise a sensor component that can receive, from microphone(s), e.g., micro-electro-mechanical system (MEMS) microphone(s), acoustic information corresponding to a sound source, e.g., mouth of a user of a wireless phone, portable communications device, e.g., cell phone, etc. including the device, and receive, from a set of sensors, e.g., a gyroscope, an accelerometer, a proximity sensor, a camera, a range sensor, etc. motion information corresponding to the device.

Further, the sensor hub can include a sensor fusion component that can determine, based on the acoustic information and the motion information, location information, coordinate information, e.g., x-axis, y-axis, and z-axis coordinates, etc. representing a location of the device with respect to the sound source. Furthermore, the sensor fusion component can send the coordinate information directed to a computing device, e.g., a system processor, an applications processor (AP), a microprocessor, etc., e.g., which can perform audio processing, e.g., beamforming, etc. based on the coordinate information.

In one embodiment, the sensor fusion component can determine, based on the motion information, an orientation of the device, an angle of arrival of an acoustic wave from the sound source, etc., and determine the coordinate information based on the orientation, angle of arrival, etc. In another embodiment, the sensor component can receive, from the set of sensors, e.g., from a proximity sensor, e.g., an ultrasonic sensor, an infrared (IR) sensor, a laser, etc. proximity information, e.g., with respect to a distance between the sound source and microphone(s) of the device. Further, the sensor fusion component can determine, based on the proximity information, the coordinate information.

In yet another embodiment, the sensor component can receive, from the set of sensors, e.g., from an ambient temperature sensor, a humidity sensor, an ambient light sensor, a gas sensor, etc. environmental information, e.g., with respect to the speed of sound. Further, the sensor fusion component can determine, based on the environmental information, the coordinate information.

In one embodiment, the device can comprise an audio component that can generate, based on the acoustic information using a filter, e.g., a digital filter, a sound-based filter, etc. audio and/or sound information. Further, the audio component can send the audio and/or sound information, e.g., as filtered data, as digital information, etc. directed to the computing device, e.g., system processor, AP, microprocessor, etc.

In another embodiment, the audio component can generate the audio and/or sound information by determining, based on the acoustic information and the coordinate information using a beamformer, e.g., spatial filter, etc. a focal point corresponding to the microphone(s). Further, the audio component can send the audio and/or sound information generated by the beamformer, spatial filter, etc. to the computing device, e.g., system processor, AP, microprocessor, etc.

In yet another embodiment, the audio component can differentiate, based on the audio and/or sound information, the sound source from another sound source with respect to a type of the sound source, e.g., distinguishing the sound source from ambient noise, e.g., music, broadcast audio, a synthesized voice, a recording, e.g., generated from a compact disk (CD), generated via a Moving Picture Group (MPEG)-3 (MP3) audio recording, etc.

In one embodiment, the audio component can perform voice recognition to distinguish a voice of a user of the device from another speaker's voice. In another embodiment, the audio component can perform speaker identification, keyword spotting, and/or voice activity detection based on acoustic information received by the sensor component.

In an embodiment, the audio component can send, based on the type of the sound source, a “wake up” signal directed to the computing device to trigger, e.g., via an interrupt of the computing device, a change of power, power state, etc. of the computing device.

In one embodiment, a system can comprise a set of sensors, a sensor hub component, and a processing component, e.g., system processor, AP, microprocessor, etc. In this regard, the set of sensors can comprise MEMS microphone(s) that can receive acoustic waves from a sound source and generate, based on the acoustic waves, acoustic information. Further, the set of sensors can comprise motion sensor(s), e.g., gyroscope(s), accelerometer(s), etc. that can detect a movement of the system and generate, based on the movement, motion information.

The sensor hub component can generate, based on the acoustic information and the motion information, coordinate information, e.g., x-axis, y-axis, and z-axis coordinates, etc. representing a location of the system with respect to the sound source. The processing component can generate, based on the acoustic information and the coordinate information, beamforming information with respect to a focal point corresponding to the MEMS microphone(s), and generate, based on the beamforming information, audio data, e.g., corresponding to the sound source.

In one embodiment, the processing component can generate, based on a filter, e.g., a digital filter, a sound-based filter, etc. the audio data. In another embodiment, the sensor hub component can determine, based on the motion information, an orientation of the device, an angle of arrival of the acoustic waves from the sound source, etc. Further the sensor hub component can determine, based on the orientation, the angle of arrival of the acoustic waves, etc. the coordinate information.

In an embodiment, a method can comprise receiving, by a device comprising a processor, acoustic signals of a sound source from microphone(s); receiving, by the device from a group of sensors comprising, e.g., a gyroscope, an accelerometer, a proximity sensor, a camera, a range sensor, an ultrasonic sensor, an IR sensor, a laser, etc. motion signals representing a movement, motion, etc. of the device; determining, by the device based on the acoustic signals and the motion signals, position information, e.g., coordinates, representing a location of the device with respect to the sound source; and sending, by the device, the position information directed to a downstream device, e.g., system processor, AP, microprocessor, etc.

In another embodiment, the determining of the position information can comprise determining, based on the motion signals, an orientation of the device, and determining, based on the orientation, the position information. In yet another embodiment, the determining of the position information can comprise determining, based on the motion signals, an angle of arrival of an acoustic wave from the sound source, and determining, based on the angle of arrival of the acoustic wave, the position information.

In one embodiment, the method can comprise sending, by the device based on the acoustic signals, audio information direct to the downstream device. In an embodiment, the method can comprise generating, by the device based on the acoustic signals using a filter, e.g., a digital filter, a sound-based filter, etc. the audio information.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Aspects of apparatus, devices, processes, and process blocks explained herein can constitute machine-executable instructions embodied within a machine, e.g., embodied in a memory device, computer readable medium (or media) associated with the machine. Such instructions, when executed by the machine, can cause the machine to perform the operations described. Additionally, aspects of the apparatus, devices, processes, and process blocks can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

Furthermore, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art having the benefit of the instant disclosure.

Conventional sound source localization technologies have had some drawbacks with respect to using one type of sensor, i.e., microphone(s), and a main processor for performing complex, audio-based sound source location algorithms. On the other hand, various embodiments disclosed herein can improve sound source identification and system power consumption by utilizing a sensor hub to process information received from microphone(s) and motion sensor(s) to determine a location, coordinates, etc. of a sound source.

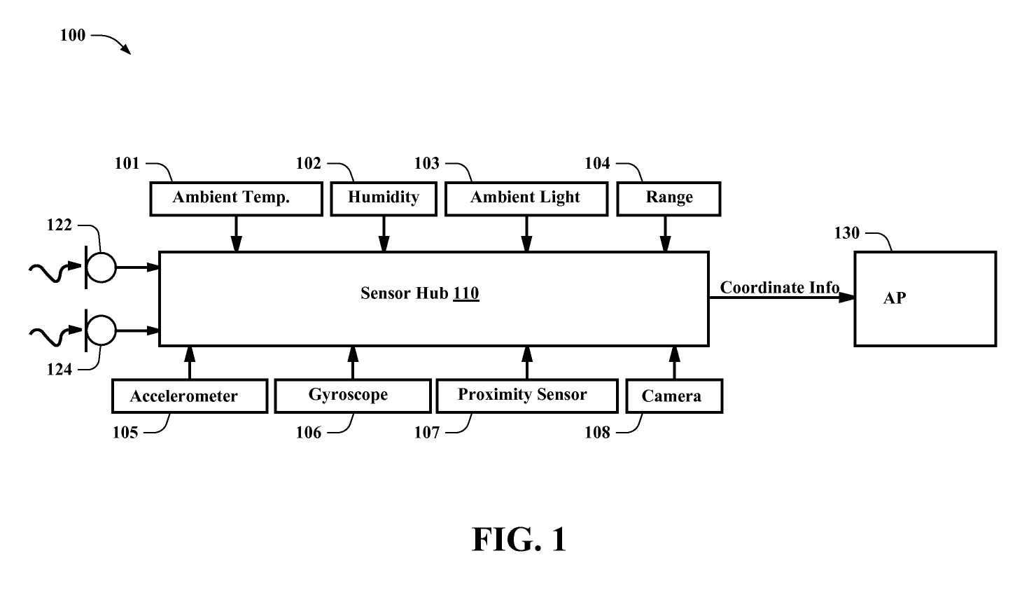

In this regard, and now referring to FIG. 1, sensor fusion environment 100 includes sensor hub 110 that can determine location, position, coordinate, etc. information of a sound source (not shown) based on acoustic information received from a set of microphones including microphone 122 and microphone 124, e.g., MEMS microphones, and motion information, proximity information, environmental information, etc. received from a set of sensors including, e.g., ambient temperature sensor 101, humidity sensor 102, ambient light sensor 103, range sensor 104 (e.g., ultrasonic based sensor, IR based sensor, a laser, etc.), accelerometer 105, gyroscope 106, proximity sensor 107 (e.g., ultrasonic based sensor, infrared (IR) based sensor, a laser, etc.), camera 108, etc. Further, sensor hub 110 can send the coordinate information directed to application processor (AP) 130, which can perform beamforming, speech enhancement, and/or noise cancelation, e.g., by “steering” a focal point of the set of microphones towards the sound source, e.g., mouth of a user of the device, based on the coordinate information.

In another embodiment, AP 130 can perform beamforming, speech enhancement, and/or noise cancelation by steering the focal point of the set of microphones away from a jammer, e.g., noise source, etc. In yet another embodiment, AP 130 can notch out, or attenuate, the jammer by steering a null, a null point, etc., e.g., located between acoustic lobes, radiation patterns, etc. of sound waves corresponding to the set of microphones, towards the jammer.

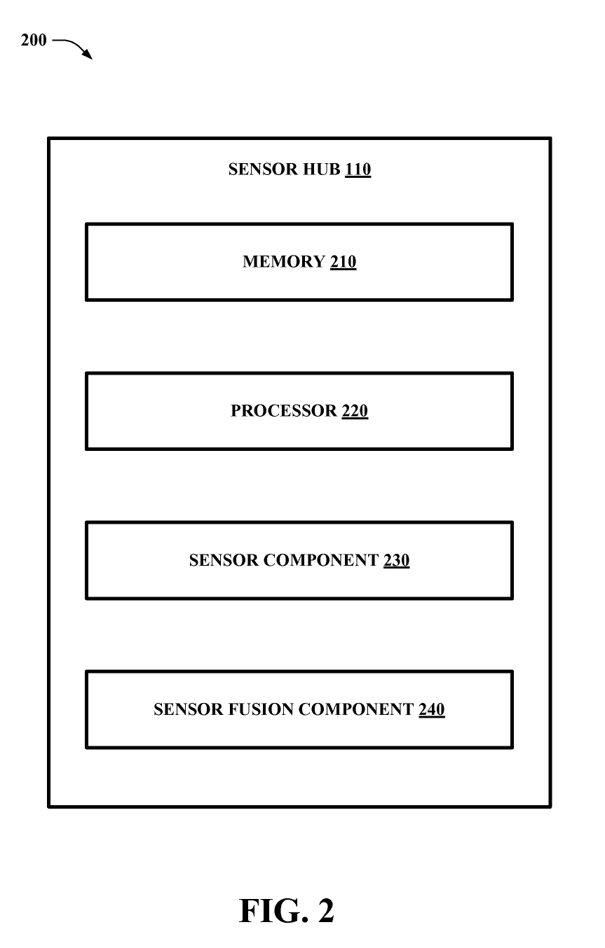

As illustrated by FIG. 2, sensor hub 110 can include memory 210 and processor 220 for performing operations corresponding to sensor component 230 and sensor fusion component 240. In this regard, sensor component 230 can be configured to receive, from microphone(s) (e.g., 122, 124), acoustic information corresponding to a sound source (not shown), e.g., mouth of a user of a device that includes sensor hub 110, e.g., wireless phone, portable communications device (e.g., cell phone), etc.

Further, sensor component 230 can receive, from a set of sensors, e.g., from range sensor 104, accelerometer 105, gyroscope 106, proximity sensor 107 (e.g., ultrasonic based sensor, IR based sensor, a laser, etc.), and/or camera 108, motion information corresponding to the device, e.g., the motion information representing whether the device is being held by the user, placed on a table, desk, etc. Sensor fusion component 240 can be configured to determine, based on the acoustic information and the motion information, coordinate information (e.g., x-axis, y-axis, and z-axis coordinates), location information, position information, etc. representing a location of the device with respect to the sound source, and send the coordinate information directed to a computing device, e.g., AP 130.

In one embodiment, sensor fusion component 240 can further be configured to determine, based on the motion information, an orientation of the device, e.g., whether the device is horizontal, vertical, etc., and determine, based on the orientation, the coordinate information. In another embodiment, sensor fusion component 240 can be configured to determine, based on the motion information, an angle of arrival of an acoustic wave from the sound source, and determine, based on the angle of arrival of the acoustic wave, the coordinate information.

In yet another embodiment, sensor component 230 can receive, from the set of sensors, e.g., from range sensor 104 and/or proximity sensor 107, proximity information, e.g., with respect to a distance between the sound source, e.g., mouth of the user, etc. and the microphone(s) (e.g., 122, 124). Further, sensor fusion component 240 can be configured to determine, based on the proximity information, the coordinate information.

In another embodiment, sensor component 230 can receive, from the set of sensors, e.g., from ambient temperature sensor 101, humidity sensor 102, ambient light sensor 103, and/or a gas sensor (not shown), environmental information, e.g., with respect to the speed of sound. Further, sensor fusion component 240 can be configured to determine, based on the environmental information, the coordinate information.

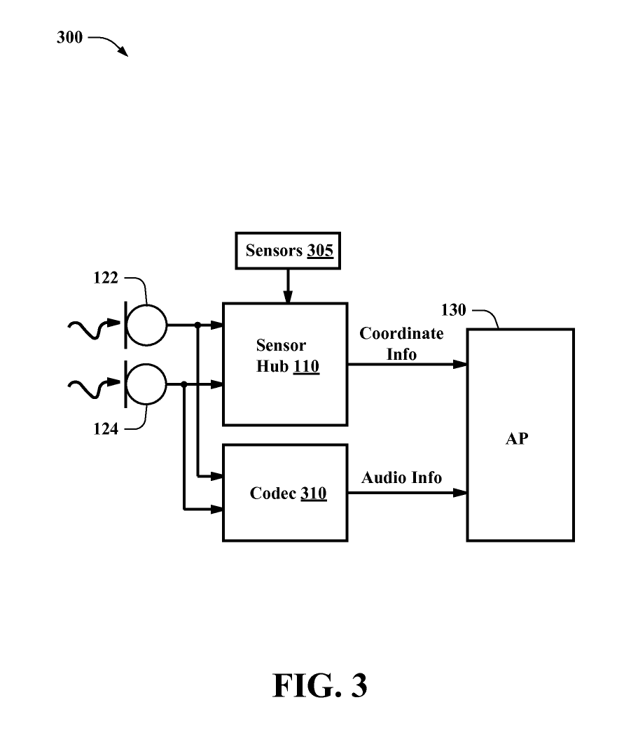

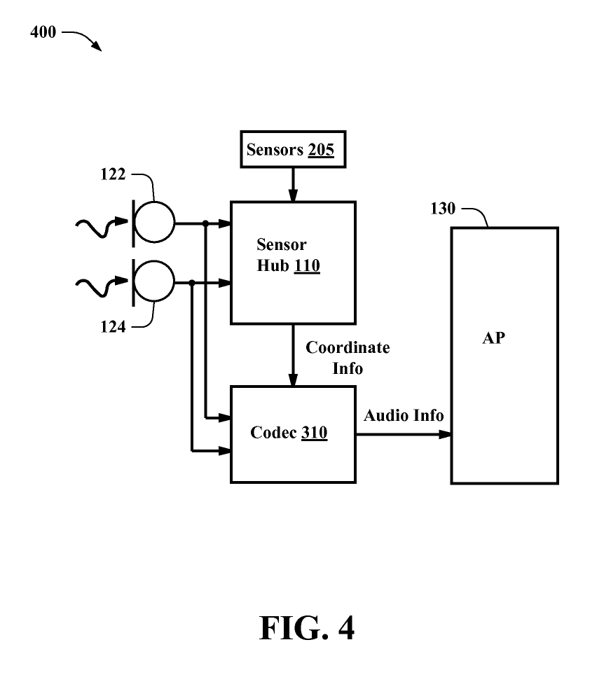

Now referring to FIGS. 3 and 4, block diagrams (300, 400) of sensor fusion environments including a coder-decoder (codec) are illustrated, in accordance with various embodiments. As illustrated by FIG. 3, codec 310 can receive acoustic signals from microphones (122, 124), and process, e.g., filter, digitize, etc. the acoustic signals to obtain audio and/or sound information. Further, codec 310 can send the audio and/or sound information to AP 130, which can use a beamformer, spatial filter, etc. to perform beamforming, speech enhancement, and/or noise cancelation utilizing coordinate information obtained from sensor hub 110 and the audio information obtained from codec 310. In another embodiment illustrated by FIG. 4, sensor hub 110 can send the coordinate information to codec 310, which can perform, using the coordinate information, beamforming, speech enhancement, and/or noise cancelation to obtain the audio and/or sound information. Further, codec 310 can send the audio and/or sound information to AP 130.

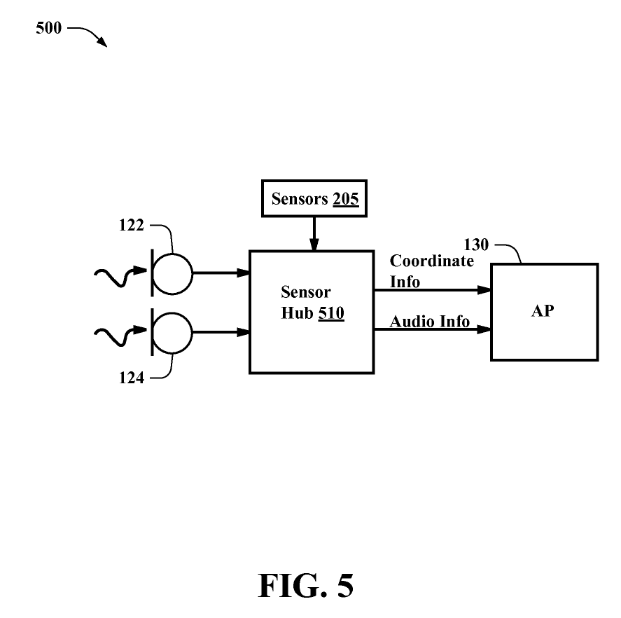

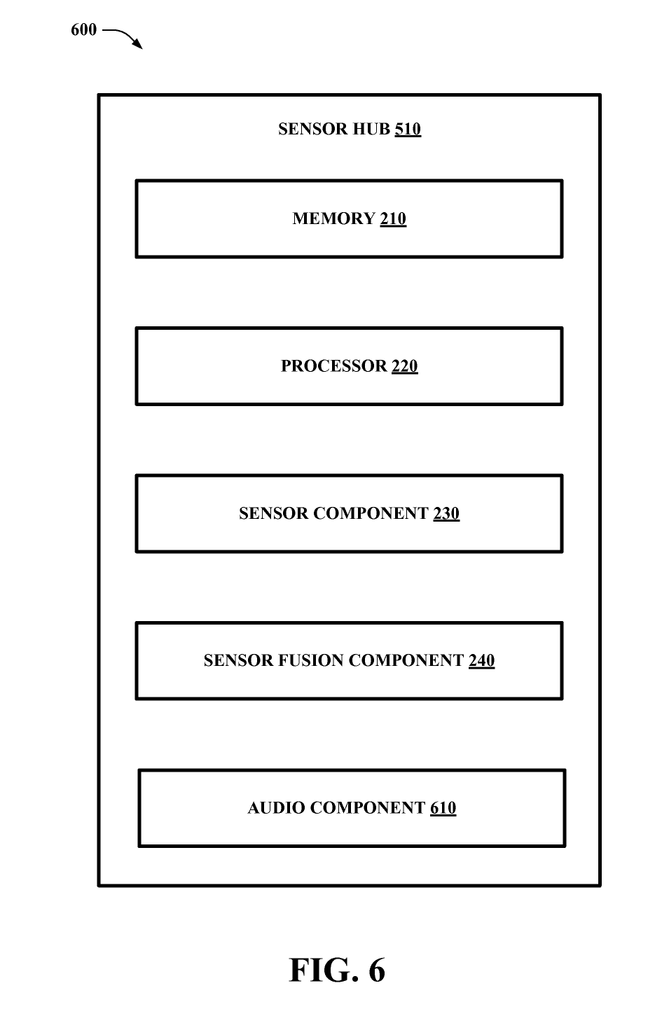

FIGS. 5, 6, and 7 illustrate block diagrams (500, 600, 700) of sensor fusion environments corresponding to a sensor hub (510) including audio component 610. In this regard, in one embodiment, audio component 610 can be configured to generate, based on acoustic information received by sensor component 230, audio information utilizing a filter, e.g., digital audio filter, etc. Further, audio component 610 can send the audio information directed to AP 130. In another embodiment, audio component 610 can comprise a codec, digital signal processor (DSP), etc. that can determine, based on acoustic information received by sensor component 230 and position information, coordinate information, etc. derived by sensor fusion component 240, beamforming information with respect to a focal point corresponding to the microphones (122, 124). For example, audio component 610 can generate the beamforming information using a beamformer, e.g., spatial filter, etc. to determine the focal point. Further, audio component 610 can generate, based on the beamforming information, the audio information.

In one embodiment, audio component 610 can be configured to differentiate, based on the audio information, the sound source from another sound source with respect to a type of the sound source, e.g., distinguishing the sound source from ambient noise, e.g., music, broadcast audio, a synthesized voice, a recording, e.g., generated from a CD, generated via an MP3 audio recording, etc. For example, audio component 610 can perform voice recognition to distinguish a voice of the user of a device including sensor hub 510, e.g., wireless phone, portable communications device (e.g., cell phone), etc. from a noise source, jammer, e.g., voice of another person, radio, etc. near sensor hub 510. In this regard, audio component 610 can utilize voice recognition, speaker identification, etc. to “assist” a beamforming process by steering an identified null, null point, etc., e.g., located between acoustic lobes, radiation patterns, etc. of sound waves corresponding to the microphones (122, 124) towards the noise source, jammer, etc., e.g., notching out and/or attenuating sound from the noise source, jammer, etc.

In another embodiment, audio component 610 can utilize such voice recognition, speaker identification, etc. to assist the beamforming process by steering a focal point corresponding to the microphones (122, 124) away from the noise source, jammer, etc. and/or towards the user.

In yet another embodiment, sensor hub 510 can learn, determine, etc., e.g., via sensor component 230 and sensor fusion component 240, that the user held the device at a particular orientation most of the time. Further, audio component 610 can assist the beamforming process, e.g., by steering the identified null and/or steering the focal point, based on the learned orientation of the device.

In another embodiment, audio component 610 can perform keyword spotting, e.g., identification of words, voice activity detection, e.g., determining whether the user of the device is speaking, etc. based on acoustic information received by sensor component 230. In an embodiment, audio component 610 can enhance the keyword spotting by using beamforming to identify whether the user of the device is speaking, e.g., by steering the focal point corresponding to the microphones (122, 124) away from a noise source, jammer, etc. and/or towards the user, and/or by steering an identified null towards the noise source, jammer, etc.

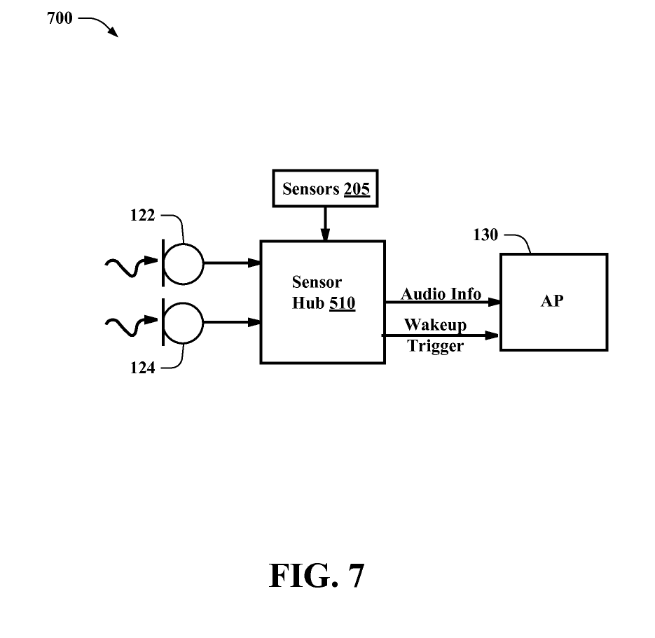

In an embodiment illustrated by FIG. 7, audio component 610 can send, based on the type of the sound source, a “wake-up trigger”, or signal, directed to AP 130, e.g., to initiate, e.g., via an interrupt, a change of state of AP 130, e.g., to initiate AP 130 to “power up”, or change its operating state from a low power, e.g., “sleep”, state to a higher power, e.g., “wakeup”, state, e.g., in response to determining that the user of the device is speaking, e.g., in an “always-on” system environment in which the system, e.g., AP 130 operates at low power levels. In one embodiment, audio component 610 can enhance derivation of the wake-up trigger by using beamforming to improve voice recognition, so that the wake-up trigger is not generated by a jammer, noise source, etc. Further, audio component 610 can improve derivation of beamforming information by utilizing position information, coordinate information, etc. derived by sensor fusion component 240 to determine a focal point corresponding to the microphones. (122, 124).

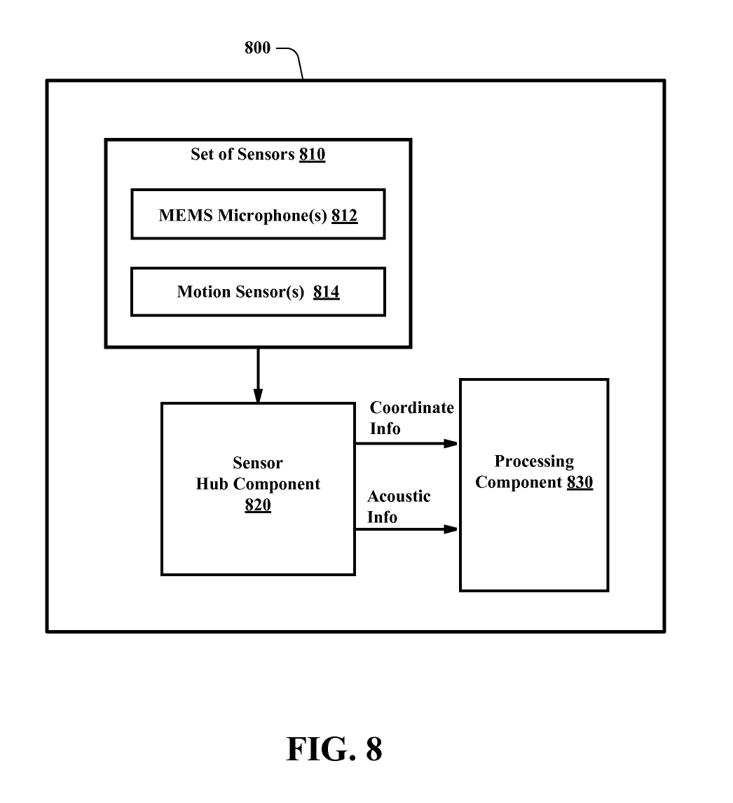

FIG. 8 illustrates a block diagram of a sensor fusion system (800) comprising set of sensors 810, sensor hub component 820, and processing component 830, in accordance with various embodiments. In this regard, sensor fusion system 800 can comprise multiple chips, dies, etc. that can be included in a package bonded to a printed circuit board (PCB) of a portable electronic device, wireless device, etc. (not shown). Set of sensors 810 comprises MEMS microphone(s) 812—configured to receive acoustic waves from a sound source (not shown), and generate, based on the acoustic waves, acoustic information—and motion sensor(s) 814, e.g., accelerometer 105, gyroscope 106, proximity sensor 107, camera 108, etc. configured to detect a movement of sensor fusion system 800 and generate, based on the movement, motion information.

Sensor hub component 820 (e.g., 510) can be configured to generate, based on the acoustic information and the motion information, coordinate information, e.g., x-axis, y-axis, and z-axis coordinates, etc. representing a location of sensor fusion system 800 with respect to the sound source. Processing component 830, e.g., AP 130, can be configured to receive the acoustic information and coordinate information from sensor hub component 820, and generate, based on such information, beamforming information with respect to a focal point corresponding to MEMS microphone(s) 812. Further, processing component 830 can be configured to generate, based on the beamforming information, audio data, e.g., using a filter, digital filter, etc.

In one embodiment, sensor hub component 820 can be configured to determine, based on the motion information, an orientation, e.g., horizontal, vertical, etc. of sensor fusion system 800. Further, sensor hub 820 can be configured to determine, based on the orientation, the coordinate information. In another embodiment, sensor hub component 820 can further be configured to determine, based on the motion information, an angle of arrival of the acoustic waves from the sound source. Further, sensor hub component 820 can determine, based on the angle of arrival of the acoustic waves, the coordinate information.

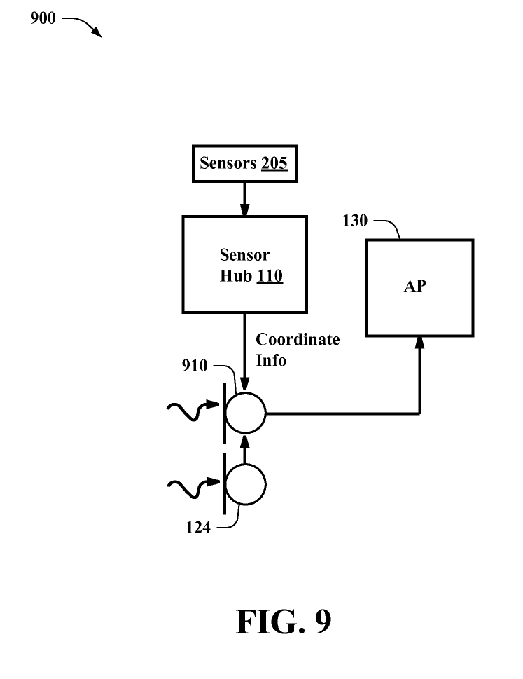

Referring now to FIG. 9, a block diagram (900) of a sensor fusion environment including a master microphone (910) is illustrated, in accordance with various embodiments. As illustrated by FIG. 9, sensor hub 110 can send derived coordinate information to master microphone 910, which can further receive acoustic information from other microphone(s) (e.g., 124). In this regard, master microphone 910 can compute a location, position, etc. of a sound source by fusing, integrating, etc. the coordinate information and the acoustic information, e.g., by performing higher-level signal processing, beamforming, speech enhancement, etc. utilizing a DSP, memory, etc. Further, master microphone 910 can perform, based on the acoustic information, audio processing, e.g., digital filtering, etc. of audio data and send processed audio data to AP 130.

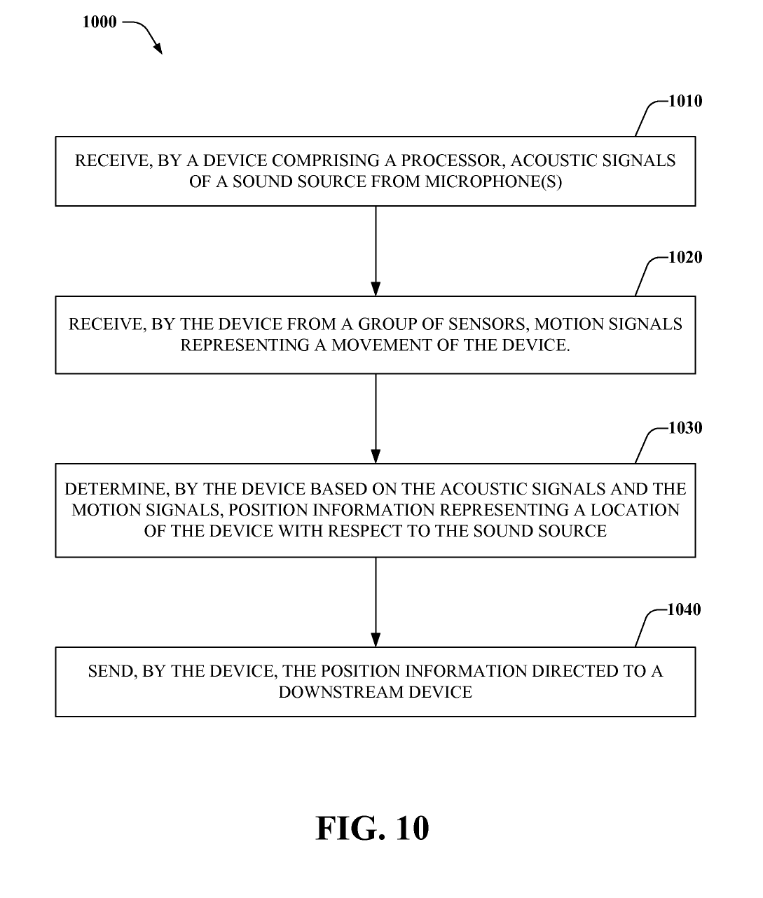

FIGS. 10-13 illustrate methodologies in accordance with the disclosed subject matter. For simplicity of explanation, the methodologies are depicted and described as a series of acts. It is to be understood and appreciated that various embodiments disclosed herein are not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that methodologies disclosed hereinafter and throughout this specification are capable of being stored on an article of manufacture to facilitate transporting and transferring such methodologies to computers, processors, processing components, etc. The term article of manufacture, as used herein, is intended to encompass a computer program accessible from any computer-readable device, carrier, or media.

Referring now to FIG. 10, process 1000 performed by a device, e.g., sensor hub 110, e.g., comprising a processor, is illustrated, in accordance with various embodiments. At 1010, the device can receive, from microphone(s), acoustic signals generated by a sound source. At 1020, the device can receive, from a group of sensors, motion signals representing a movement, orientation, position, etc. of the device. At 1030, the device can determine, based on the acoustic signals and the motion signals, position, coordinate, etc. information representing a location of the device with respect to the sound source. In one embodiment, the device can determine, based on the motion signals, an orientation of the device and/or an angle of arrival of an acoustic wave from the sound source. Further, the device can determine the position information based on the orientation of the device and/or the angle of arrival of the acoustic wave.

At 1040, the device can send the position information directed to a downstream device, e.g., AP 130. In this regard, the downstream device can be configured to perform beamforming, speech enhancement, and/or noise cancelation, e.g., by steering a focal point of the set of microphones towards the sound source, e.g., mouth of a user of the device, based on the coordinate information. In an embodiment, the device can send, based on the acoustic signals, audio information directed to the downstream device. In another embodiment, the device can generate the audio information using a digital filter.

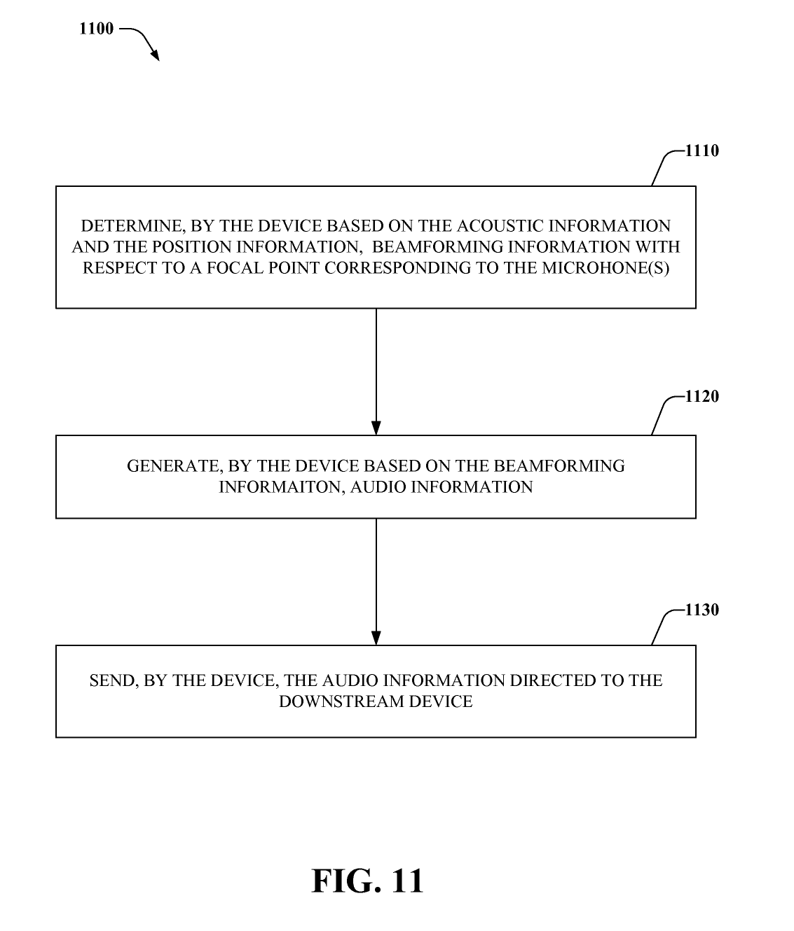

FIG. 11 illustrates another process (1100) performed by the device, e.g., sensor hub 110, in accordance with various embodiments. At 1110, the device can determine, based on the acoustic information and the position information, beamforming information with respect to a focal point corresponding to the microphone(s), e.g., utilizing a DSP, etc. At 1120, the device can generate, based on the beamforming information, audio information. At 1130, the device can send the audio information directed to the downstream device, e.g., AP 130.

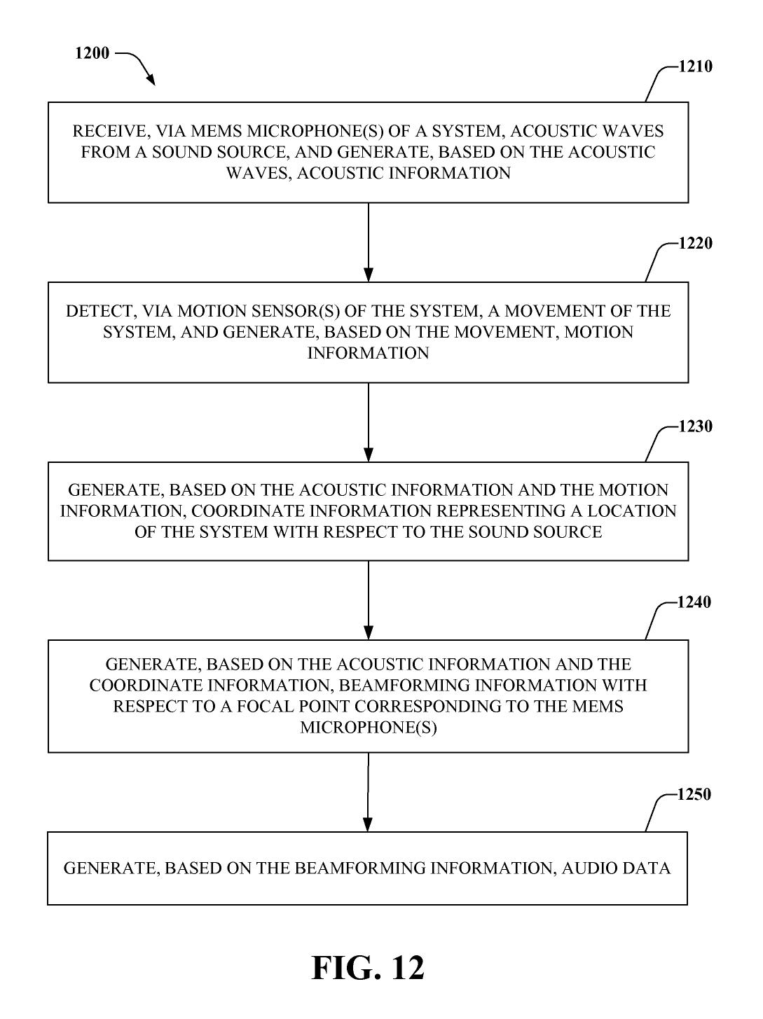

FIG. 12 illustrates a process (1200) performed by a sensor fusion system, e.g., sensor fusion system 800, in accordance with various embodiments. At 1210, MEMS microphone(s) of the sensor fusion system can receive acoustic waves from a sound source, and generate, based on the acoustic waves, acoustic information. At 1220, motion sensor(s), e.g., accelerometer, gyroscope, proximity sensor, camera, etc. of the sensor fusion system can detect a movement of the sensor fusion system, and generate, based on the movement, motion information. At 1230, the sensor fusion system can generate, based on the acoustic information and the motion information, e.g., via sensor hub component 820, coordinate information representing a location of the sensor fusion system with respect to the sound source. At 1240, the sensor fusion system can generate, based on the acoustic information and the coordinate information, e.g., via processing component 830, beamforming information with respect to a focal point corresponding to the MEMS microphone(s). At 1250, the sensor fusion system can generate, based on the beamforming information via processing component 830, audio data.

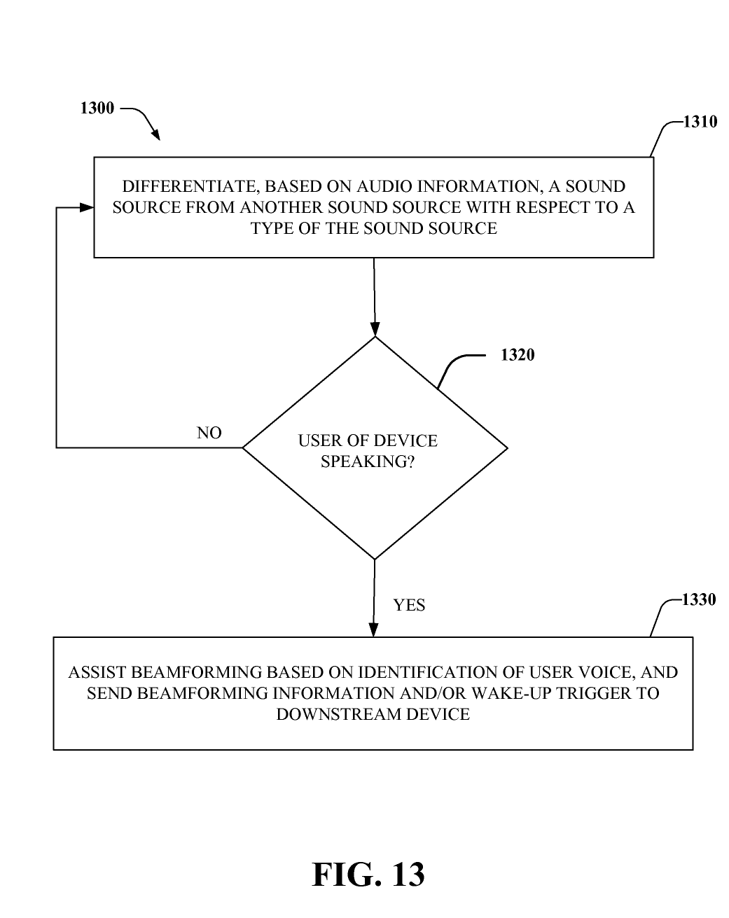

FIG. 13 illustrates a processes (1300) corresponding to a sensor hub (e.g., 510) including an audio component (e.g., 610), in accordance with various embodiments. At 1310, the sensor hub can differentiate, based on audio information generated via the audio component, a sound source form another sound source with respect to a type of the sound source, e.g., distinguishing the sound source from a jammer, ambient noise, e.g., music, broadcast audio, a synthesized voice, a recording, e.g., generated from a CD, generated via an MP3 audio recording, etc. At 1320, in response to a determination, via the audio component utilizing voice recognition to distinguish a voice of the user of the device from that of another speaker, that the user of the device is speaking, flow continues to 1330, in which recognition of the user's voice, e.g., speaker identification, can be used by the sensor hub to “assist” beamforming, microphone array processing, etc., e.g., to steer a focal point corresponding to microphones coupled to the sensor hub towards the user. Further, the sensor hub can send associated beamforming information to a downstream device, and/or a “wake-up trigger”, signal, etc. to a downstream device, e.g., for initiating a change in power state of a downstream device, e.g., AP 130; otherwise flow returns to 1310.

As it employed in the subject specification, the terms “processor”, “processing component”, etc. can refer to substantially any computing processing unit or device, e.g., processor 220, AP 130, processing component 830, etc. comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Further, a processor can exploit nano-scale architectures such as, but not limited to, molecular and quantum-dot based transistors, switches and gates, e.g., in order to optimize space usage or enhance performance of mobile devices. A processor can also be implemented as a combination of computing processing units, devices, etc.

In the subject specification, terms such as “memory” and substantially any other information storage component relevant to operation and functionality of systems and/or devices disclosed herein, e.g., memory 210, refer to “memory components,” or entities embodied in a “memory,” or components comprising the memory. It will be appreciated that the memory can include volatile memory and/or nonvolatile memory. By way of illustration, and not limitation, volatile memory, can include random access memory (RAM), which can act as external cache memory. By way of illustration and not limitation, RAM can include synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and/or Rambus dynamic RAM (RDRAM). In other embodiment(s) nonvolatile memory can include read only memory (ROM), programmable ROM (PROM), electrically programmable ROM (EPROM), electrically erasable ROM (EEPROM), or flash memory. Additionally, the MEMS microphones and/or devices disclosed herein can comprise, without being limited to comprising, these and any other suitable types of memory.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A device, comprising:
a sensor component configured to:
receive, from at least one microphone, acoustic information corresponding to a sound source; and
receive, from a set of sensors, motion information corresponding to the device; and
a sensor fusion component configured to:
determine, based on the acoustic information and the motion information, coordinate information representing a location of the device with respect to the sound source; and
send the coordinate information directed to a computing device.

2. The device of claim 1, wherein the sensor fusion component is further configured to:
determine, based on the motion information, an orientation of the device; and
determine, based on the orientation, the coordinate information.

3. The device of claim 1, wherein the sensor fusion component is further configured to:
determine, based on the motion information, an angle of arrival of an acoustic wave from the sound source; and
determine, based on the angle of arrival of the acoustic wave, the coordinate information.

4. The device of claim 1, wherein the sensor component is further configured to receive, from the set of sensors, proximity information, and wherein the sensor fusion component is further configured to determine, based on the proximity information, the coordinate information.

5. The device of claim 1, wherein the sensor component is further configured to receive, from the set of sensors, environmental information, and wherein the sensor fusion component is further configured to determine, based on the environmental information, the coordinate information.

6. The device of claim 1, further comprising an audio component configured to:
generate, based on the acoustic information using a filter, audio information; and
send the audio information directed to the computing device.

7. A device, comprising:
a sensor component configured to:
receive, from at least one microphone, acoustic information corresponding to a sound source; and
receive, from a set of sensors, motion information corresponding to the device;
a sensor fusion component configured to determine, based on the acoustic information and the motion information, coordinate information representing a location of the device with respect to the sound source; and
an audio component configured to:
determine, based on the acoustic information and the coordinate information, beamforming information with respect to a focal point corresponding to the at least one microphone;
generate, based on the beamforming information, audio information; and
send the audio information directed to a computing device.

8. The device of claim 7, wherein the sensor fusion component is further configured to:
determine, based on the motion information, an orientation of the device; and
determine, based on the orientation, the coordinate information.

9. The device of claim 7, wherein the audio component is further configured to generate the audio information using a filter.

10. The device of claim 7, wherein the audio component is further configured to differentiate, based on the audio information, the sound source from another sound source with respect a type of the sound source.

11. The device of claim 10, wherein the audio component is further configured to send, based on the type of the sound source, a wake up signal directed to the computing device to facilitate a change of power of the computing device.

12. A system, comprising:
a set of sensors comprising:
at least one micro-electro-mechanical system (MEMS) microphone configured to receive acoustic waves from a sound source and generate, based on the acoustic waves, acoustic information; and
at least one motion sensor configured to detect a movement of the system and generate, based on the movement, motion information;
a sensor hub component configured to generate, based on the acoustic information and the motion information, coordinate information representing a location of the system with respect to the sound source; and
a processing component configured to:
generate, based on the acoustic information and the coordinate information, beamforming information with respect to a focal point corresponding to the at least one MEMS microphone; and
generate, based on the beamforming information, audio data.

13. The system of claim 12, wherein the processing component is further configured to generate, based on a filter, the audio data.

14. The system of claim 12, wherein the sensor hub component is further configured to:
determine, based on the motion information, an orientation of the device; and
determine, based on the orientation, the coordinate information.

15. The system of claim 12, wherein the sensor hub component is further configured to:
determine, based on the motion information, an angle of arrival of the acoustic waves from the sound source; and
determine, based on the angle of arrival of the acoustic waves, the coordinate information.

16. A method, comprising:
receiving, by a device comprising a processor, acoustic signals of a sound source from at least one microphone;
receiving, by the device from a group of sensors, motion signals representing a movement of the device;
determining, by the device based on the acoustic signals and the motion signals, position information representing a location of the device with respect to the sound source; and
sending, by the device, the position information directed to a downstream device.

17. The method of claim 16, wherein the determining the position information comprises:
determining, based on the motion signals, an orientation of the device; and
determining, based on the orientation, the position information.

18. The method of claim 16, wherein the determining the position information comprises:
determining, based on the motion signals, an angle of arrival of an acoustic wave from the sound source; and
determining, based on the angle of arrival of the acoustic wave, the position information.

19. The method of claim 16, further comprising:
sending, by the device based on the acoustic signals, audio information directed to the downstream device.

20. The method of claim 19, further comprising:
generating, based on the acoustic signals using a filter, the audio information.
